(19) United States
(12) Patent Application Publication
(10) Pub. No.: US 2018/0257083 A1
(43) Pub. Date: Sep. 13, 2018

(54) GRINDER

(71) Applicant: Hongfu WANG, Zhengzhou (CN)

(72) Inventor: Hongfu WANG, Zhengzhou (CN)

(21) Appl. No.: 15/978,183

(22) Filed: May 13, 2018

Related U.S. Application Data
(63) Continuation-in-part of application No. PCT/CN2016/100235, filed on Sep. 27, 2016.

(30) Foreign Application Priority Data
Nov. 18, 2015 (CN) 201510793292.3

(51) Int. Cl. B02C 18/14; B02C 23/00; B02C 19/00

(52) U.S. Cl. CPC B02C 18/146; B02C 18/148; B02C 19/00; B02C 23/00

(57) ABSTRACT

A grinder, including a motor, a machine shell, a rotor unit, and a stator unit. The rotor unit includes a wheel hub, a rotor disk fixed on the wheel hub, and at least 3 rounds of the rotor pins installed on the rotor disk. The stator unit includes a cover plate, a stator disk fixed on the cover plate, and at least 3 rounds of the stator pins installed on the stator disk. The cover plate is fixedly connected to the top surface of the machine shell, and the motor is fixedly connected to the bottom surface of the machine shell. The rotor unit is disposed in the machine shell and fixedly connected to the motor shaft via the wheel hub. The rotor pins and the stator pins each include a quadrangular steel billet and a screwed or non-screwed connecting rod disposed on the steel billet.

### CROSS-REFERENCE TO RELATED APPLICATIONS

This application is a continuation-in-part of International Patent Application No. PCT/CN2016/100235 with an international filing date of Sep. 27, 2016, designating the United States, now pending, and further claims foreign priority benefits to Chinese Patent Application No. 201510793292.3 filed Nov. 18, 2015. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

This disclosure relates to the field of mechanical equipment, and more particularly, to a high-speed extrusion cutting grinder.

Material grinders are known. However, many conventional material grinders are designed for materials having relatively uniform properties.

### SUMMARY

Disclosed is a grinder that can be used for pulverizing cereal and oil plants, plant roots, stems, leaves and seeds, and solid particle materials such as ores, rubbers, and plastics.

Disclosed is a grinder comprising a motor comprising a motor shaft; a machine shell comprising a top surface and a bottom surface; a rotor unit, the rotor unit comprising a wheel hub, a rotor disk fixed on the wheel hub, and at least 3 rounds of the rotor pins installed on the rotor disk; and a stator unit, the stator unit comprising a cover plate, a stator disk fixed on the cover plate, and at least 3 rounds of the stator pins installed on the stator disk. The cover plate is fixedly connected to the top surface of the machine shell, and the motor is fixedly connected to the bottom surface of the machine shell; the rotor unit is disposed in the machine shell and fixedly connected to the motor shaft via the wheel hub; the stator unit is fixed on the top surface of the machine shell via the cover plate; the rotor pins and the stator pins are the same in structure; each of the rotor pins and the stator pins comprises a quadrangular steel billet and a screwed or non-screwed connecting rod disposed on the steel billet; a cross section of the quadrangular steel billets is square; an anti-abrasion component is fixed on the quadrangular steel billet of the rotor/the stator pins; the anti-abrasion component comprises two level parts and a V-shaped part; the two level parts are fixed on ends of two inclined faces of the V-shaped part, respectively; both the two level parts and the two inclined faces of the V-shaped part are disposed symmetrically about a center of the quadrangular steel billet; the two level parts each comprise two to six steps; the V-shaped part comprises an arc-shaped apical part, and an included angle α formed by the two inclined faces of the V-shaped part is between 80 and 140 degrees; the two inclined faces and the arc-shaped apical part of the V-shaped part form a radial working face of the rotor/the stator pins, and the two to six steps of the two level parts form a tangential working face of the rotor/the stator pins; inner and outer tangential working faces of the rotor pins and the inner and outer tangential working faces of the stator pins are peripherally tangential to a movement direction of the motor; and arc faces of the radial working faces of the rotor pins and arc faces of the radial working faces of the stator pins are opposite to one another.

The anti-abrasion component can have a thickness of at least 2 millimeters; and the height of the steps can increase from 0.5 mm to 1.5 mm from the front direction to the rear direction successively, taking the direction of the steps of the inner or outer tangential working faces of the anti-abrasion component close to the radial working face as the front direction, and the direction far from the radial working face as the rear direction.

The width of a bottommost step of the inner or outer tangential working faces of the anti-abrasion component can be no less than 1 mm; a width of an uppermost step of the inner or outer tangential working faces of the anti-abrasion component can range from 3 mm to 15 mm.

The steel billet and the anti-abrasion component can be connected using soldering joint or bonding joint.

A minimum space between the rotor pins and the stator pins can range from 0.5 mm to 3 mm.

A linear velocity of the rotor pins can range from 50 meters per second to 150 meters per second.

A top surface of the cover plate can be provided with a plurality of first annular water channels; one end of the first annular water channels can communicate with an inlet tube, and the other end of the first annular water channels can communicate with an outlet tube.

The bottom surface of the machine shell can be provided with a plurality of the second annular water channels; the second annular water channels can comprise a volute water channel and a bottom case water channel; one end of the volute water channel can be connected to one end of the bottom case water channel through a water mouth; the other end of the volute water channel can communicate with an inlet tube of the second annular water channels, and the other end of the bottom case water channel can communicate with an outlet tube of the second annular water channels.

The water mouth can be rectangular.

A heat-conducting plate can be disposed between the stator disk and the cover plate.

Advantages of the grinder in the disclosure are summarized as below:

1. The application range of the device is widened, and the lifespan of the rotor pins and the stator pins is elongated.

2. The relative amount of materials entering onto the tangential working face is increased.

3. The relative extrusion cutting forces generated by rotor pins and the stator pins are increased.

4. The linear velocity of the rotor pins is increased.

5. The particle sizes of pulverized materials can be controlled by changing the minimum space between the pins and slightly adjusting the speed of the rotors, which at the same time ensures the quality of pulverized products and improves operating parameters.

6. The temperature of the pulverized material is lowered.

7. The high-speed grinder provided in the disclosure can be used in various fields such as grain processing, fodder processing, metallurgy, chemical engineering, plastics, pharmaceuticals, architectures, electronics and energy industries.

8. The high-speed grinder provided in the disclosure can effectively pulverize almost all solid particle materials such as grains, oil plants, sorts of plant roots, stems, leaves and seeds, ores, rubbers and plastics.

### BRIEF DESCRIPTION OF THE DRAWINGS

FIG. 1 is a schematic diagram of a grinder of the disclosure.

FIG. 2 is a schematic diagram of a pin.

FIG. 3 is a top view of the pin of FIG. 2.

FIG. 4 demonstrates a schematic view of installed rotor pins and the stator pins.

FIG. 5 is an enlarged view when the space between the rotor pin and the stator pin of FIG. 4 is at a maximum.

FIG. 6 is an enlarged view when the space between the rotor pin and the stator pin of FIG. 4 is at a minimum.

FIG. 7 a schematic diagram of a grinder of the disclosure.

FIG. 8 is a front view of a cover plate.

FIG. 9 is a top view of the cover plate in FIG. 8.

FIG. 10 is a front view of a machine shell.

FIG. 11 is a top view of the machine shell in FIG. 10.

### DETAILED DESCRIPTION

To further illustrate, experiments detailing a grinder are described below. It should be noted that the following examples are intended to describe and not to limit the description.

### Example 1

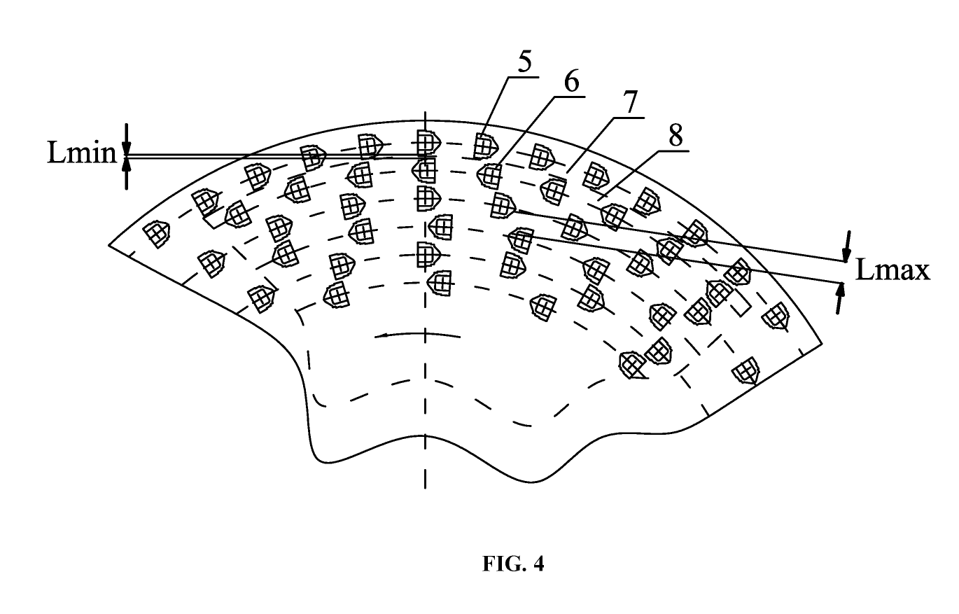

Description of directions: the direction of the units, for example, a stator pin 5, on the stator disk 7, close to the axis of the stator disk 7, is defined as inward while the opposite direction as outward; the direction of the units, for example, a rotor pin 6, on the rotor disk 8, far from the axis of rotor disk 8, is defined as outward while the opposite direction as inward. The direction which the curved arrow in FIG. 4 points to is the direction of the rotation of the rotor disk 8.

Related definitions: the minimum space between the highest step of the tangential working face 122 outward the level part of the rotor pin 6 and the highest step of the tangential working face 122 inward the level part of the nearest the stator pin 5, or the minimum space between the highest step of the tangential working face 122 inward the level part of the rotor pin 6 and the highest step of the tangential working face 122 outward the level part of the nearest the stator pin 5, can be regarded as minimum space between the rotor pin 6 and the stator pin 5.

When certain rotor pin 6 moving towards its outward the stator pin 5, the maximum space between the start point of outward apical inclined face of the radial working face 121 of the rotor pin 6 and the start point of inward apical inclined face of the radial working face 121 of the stator pin 5, can be regarded as the maximum space Lₘₐₓ between the rotor pin 6 and the stator pin 5.

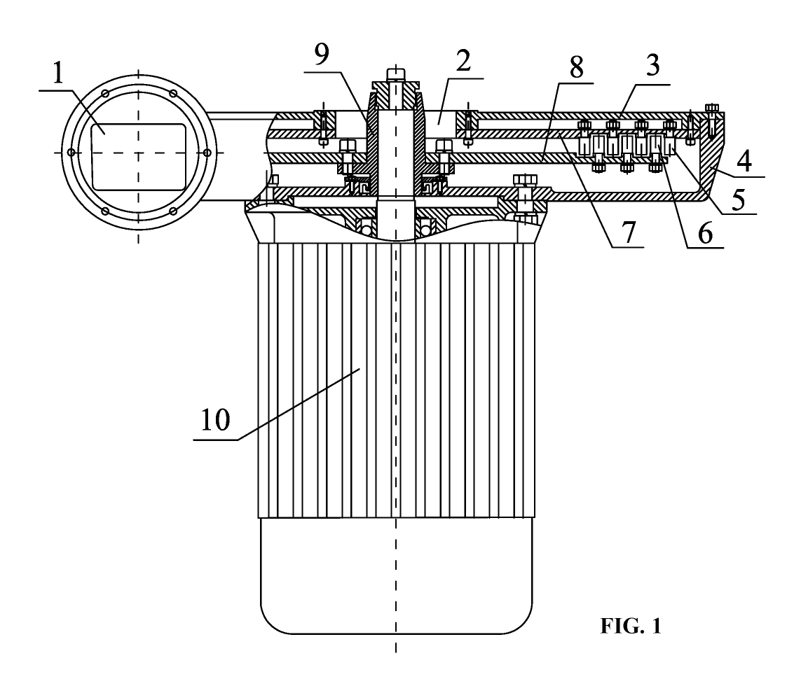

As shown in FIG. 1, the disclosure provides a high-speed grinder which comprises a motor 10, a machine shell 4, a cover plate 3, a rotor unit and a stator unit. The cover plate 3 is fixed on the top surface of the machine shell 4. The motor 10 is fixed on the bottom surface of the machine shell 4. The machine shell 4 is a discoid shell with high edges surrounded. There is a rectangular material outlet hole 1 along the tangential direction of the machine shell 4. The material inlet hole 2 is located at the center of the cover plate 3 which is fixed on the top surface of the machine shell 4.

As shown in FIG. 1 and FIG. 4, the rotor unit comprises a wheel hub 9, a rotor disk 8 which is fixed on the wheel hub 9 and at least three rounds of rotor pins 6 installed on the rotor disk 8. The rotor pins 6 are distributed evenly about the central axis of rotor disk 8 along the peripheral direction. The rotor unit is disposed inside the machine shell 4 and fixedly connected to a motor shaft through the wheel hub 9.

The stator unit comprises a cover plate 3, a stator disk 7 fixed on the cover plate 3 and at least three rounds of stator pins 5 installed on the stator disk 7. The stator pins 5 are distributed evenly about the central axis of the stator disk 7 along the peripheral direction. The stator unit is fixed on the surface of the machine shell 4 through the cover plate 3.

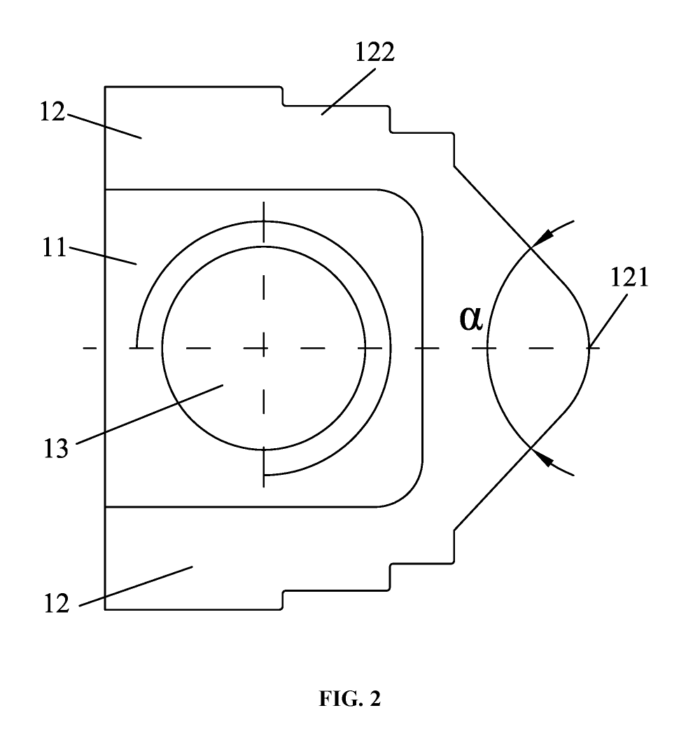

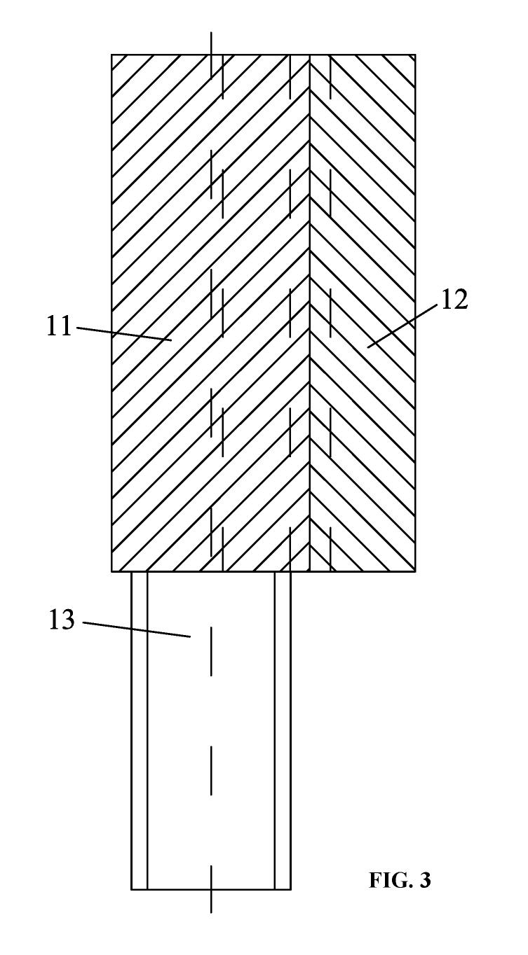

As shown in FIG. 2 and FIG. 3, the rotor pins 8 and the stator pins 7 are the same in structure, comprising quadrangular steel billet 11 whose cross section is square and a screwed or non-screwed connecting rod 13 on the steel billet 11. An anti-abrasion component 12 is fixed on the quadrangular steel billet 11 of the rotor pin 6 or the stator pin 5. Fixed joint between the steel billet 11 and the anti-abrasion component 12 is soldering joint or bonding joint. The anti-abrasion component 12 is made of cemented carbide or ceramic materials.

The anti-abrasion component 12 comprises two level parts and a V-shaped part. The two-level parts are fixed on the end of the two inclined faces of V-shaped part respectively, both the two-level parts and two inclined faces of the V-shaped part are disposed symmetrically about a center of the quadrangular steel billet 11. The level part comprises two to six steps. The V-shaped part comprises an arc-shaped apical part and the included angle of the two inclined faces is between 80 and 140 degrees. The radial working face 121 results from two inclined faces and arc face of the V-shaped part, while the tangential working face 122 results from the two to six steps of the two-level parts.

With respect to the steps of the inner or outer tangential working faces 122 of the anti-abrasion component 12, the direction nearer to the radial working face 121 is regarded as front direction, while the direction farther from from radial working face 121 is regarded as rear direction. The height of the steps increased from 0.5 mm to 1.5 mm along the direction from front to rear successively. The width of the bottommost steps of the inner or outer tangential working faces 122 of the anti-abrasion component 12 is no less than 1 mm. The width of the uppermost steps of the inner or outer tangential working faces 122 of the anti-abrasion component 12 is between 3 mm and 15 mm. All positions of the quadrangular steel billet 11 which may directly contact material particle surfaces are protected by the at least 2 mm thick anti-abrasion component 12. Meanwhile, the uppermost steps of the anti-abrasion component 12 has a width ranging from 3 mm to 15 mm. The anti-abrasion component 12 is made of cemented carbide or ceramic materials.

The arc faces of the radial working faces 121 of the rotor pins 6 and the arc faces of the radial working faces 121 of the stator pins 5 are opposite to one another. The inner and outer tangential working faces 122 of the rotor pins 6 and the inner and outer tangential working faces 122 of the stator pins 5 are all tangential to the peripheral direction of the motor movement.

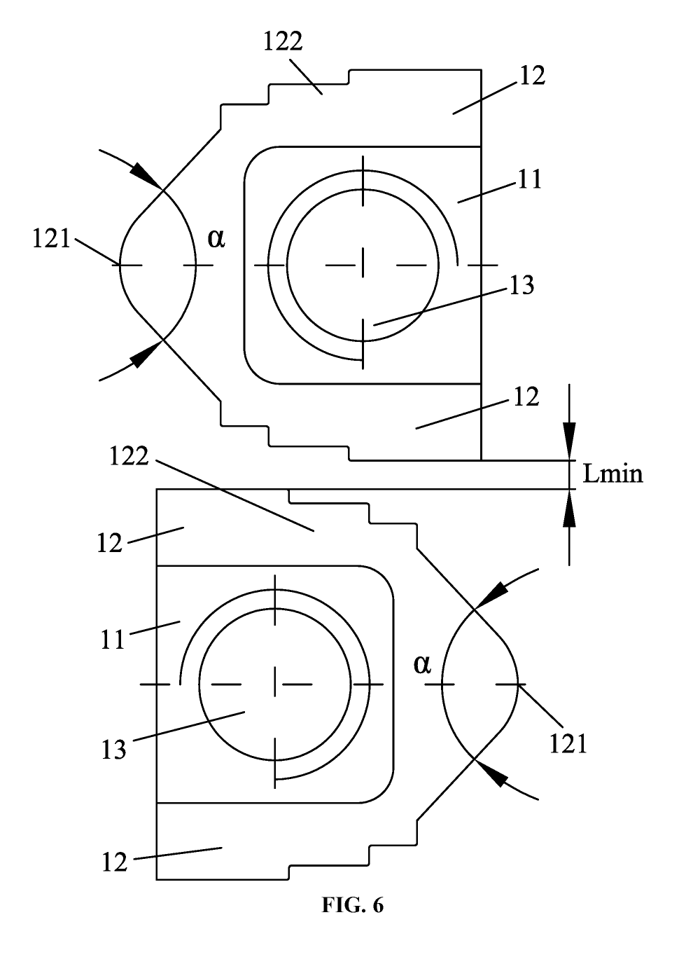

As shown in FIG. 4 and FIG. 6, the minimum space between the highest step of the tangential working face 122 outward of the rotor pin 6 and the highest step of the tangential working face 122 inward of the nearest the stator pin 5, or the minimum space between the highest step of the tangential working face 122 inward of the rotor pin 6 and the highest step of the tangential working face 122 outward of the nearest the stator pin 5, can be regarded as minimum space Lₘᵢₙ between the rotor pin 6 and the stator pin 5. The minimum space Lₘᵢₙ between the rotor pin 6 and the stator pin 5 is between 0.5 mm and 3 mm.

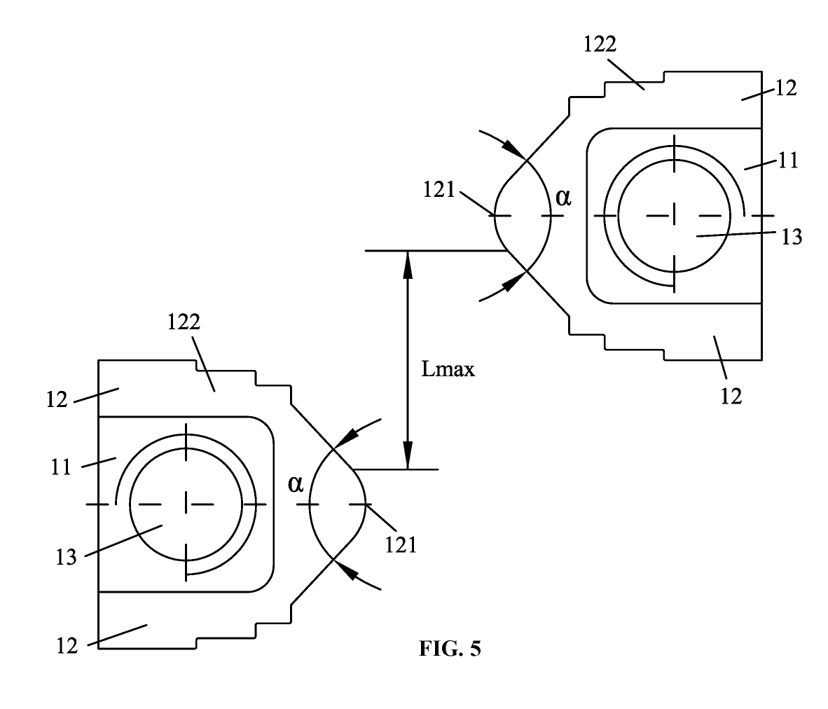

As shown in FIG. 4 and FIG. 5, when certain rotor pin 6 moving towards its outward the stator pin 5, the maximum space between the start point of outward apical inclined face of the radial working face 121 of the rotor pin 6 and the start point of inward apical inclined face of the radial working face 121 of the stator pin 5, can be regarded as the maximum space Lₘₐₓ between the rotor pin 6 and the stator pin 5. The maximum space Lₘₐₓ between the rotor pin 6 and the stator pin 5 is between 10 mm and 20 mm.

As shown in FIG. 5 and FIG. 6, in use, the radial space between the rotor pins 6 and the stator pins 5 is always changing from maximum space Lₘₐₓ to minimum space Lₘᵢₙ.

In use, materials enter the space between rotor disk 8 and stator disk 7 inside machine shell 4 through the inlet hole 2 on the cover plate 3. Motor 10 drives the rotor unit to rotate. The centrifugal force, wind power and impact force from rotor pins 6 generated by high-speed rotating rotor unit compel materials moving through the narrow space between the rotor pins 6 and the stator pins 5 from the center to periphery of the machine shell 4, and finally expelled from outlet hole 1 on the machine shell 4. During operation, the radial space between any rotor pin 6 and incoming the stator pin 5 is a process changing from maximum space Lₘₐₓ to minimum space Lₘᵢₙ, which is also the whole process of extrusion cutting pulverization in the disclosure. Since the particle size of unpulverized materials is required to no larger than Lₘₐₓ, and Lₘᵢₙ can be designed in the range from 0.5 mm to 3 mm (almost all grinders of same sorts require the particle size of unpulverized material to be larger than 0.5 mm), when the movement of the rotor pin 6 makes the space between the rotor pin 6 and the stator pin 5 reaching or surpassing Lₘₐₓ, with Lₘₐₓ setting from 10 mm to 20 mm, the solid particles must be clamped between the rotor pin 6 and the stator pin 5. The unusually large extrusion cutting force will rapidly pulverize big particles clamped between radial working face 121 of the rotor pin 6 and radial forking face 121 of the stator pin 5 into small particles, then these small particles will be pulverized again when entering tangential working face 122.

Since the shear strength of almost all solid particle materials is only about half of the compressive strength, extrusion cutting force generated by rotor pin 6 and the stator pin 5 simultaneously is much bigger than impact force generated by rotor pin hitting the material particles. Radial working face 121 of the pins (in particular, the arc face at the apical intersection of two inclined faces) can divide the incoming materials into both two sides evenly, aggregating materials onto the tangential working face 122 for pulverization, which is crucial for improved pulverizing and efficiency.

Theoretically, as to material particles with particle size smaller than Lₘᵢₙ, there is no possibility of them to contact with rotor pin 6 and the stator pin 5 simultaneously, which may make the pulverizing function idle. But during actual operation, when tangential working face 122 aggregating as many material particles, not only particles smaller than Lₘᵢₙ but also bigger particles mix together in the space, which means that material particles with size smaller than Lₘᵢₙ still can be pulverized by extrusion cutting. The minimum space Lₘᵢₙ is between 0.5 mm and 3 mm. In addition, the linear velocity of pin movement on rotors is between 20 meters per second and 100 meters per second under rotational speed 1000 rpm to 3000 rpm. Such high velocity of extrusion cutting can easily pulverize ductile materials such as rubbers and plastics with high efficiency.

During operation, the stator pins 6 drive materials to move circularly meanwhile from the center to periphery of the rotor, then expelled from outlet hole 1 on the machine shell 4. As to a single rotor pin 6, the material particles are processed just once.

### Example 2

In this example, a water-cooling unit is added to the grinder of example 1.

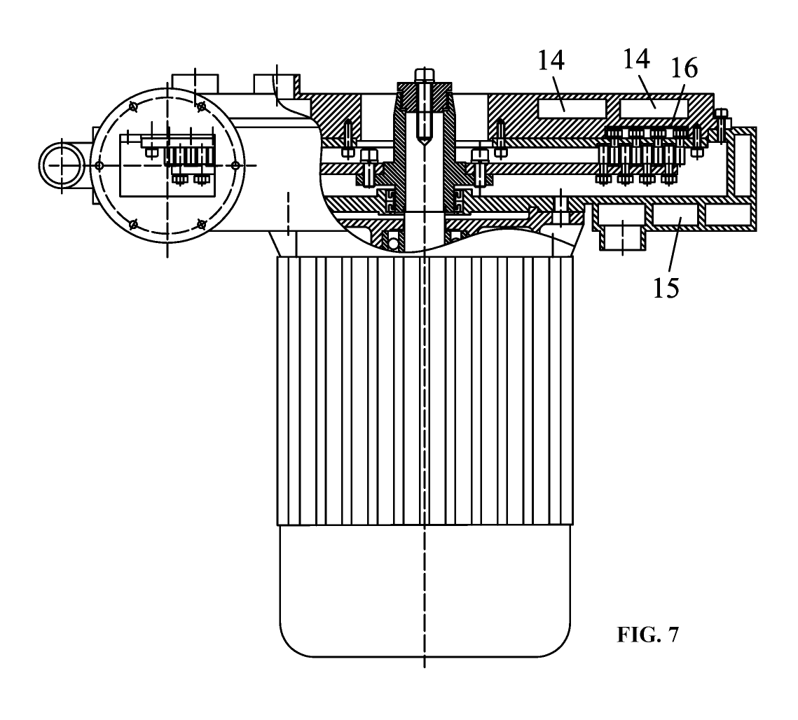

As shown in FIG. 7, the water channel 14 is disposed inside the cover plate 3, and second annular water channel 15 is disposed inside the machine shell 4. There is heat-conducting plate 16 between cover plate 3 and stator disk 7. The bottom surface of aluminum made heat-conducting plate 16 is fixed tightly with the stator pins 5 and the nut used to install the stator pin 5. The top surface of heat-conducting plate 16 is fixed tightly with the bottom surface of the cover plate 3.

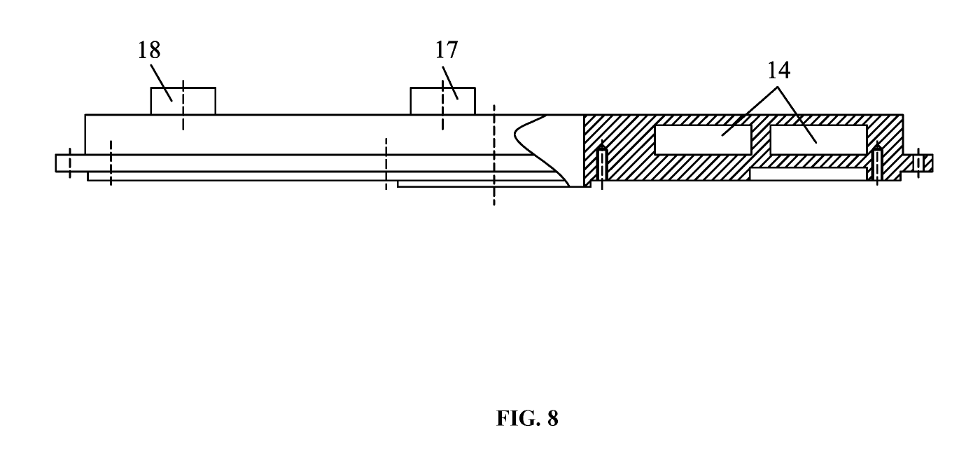

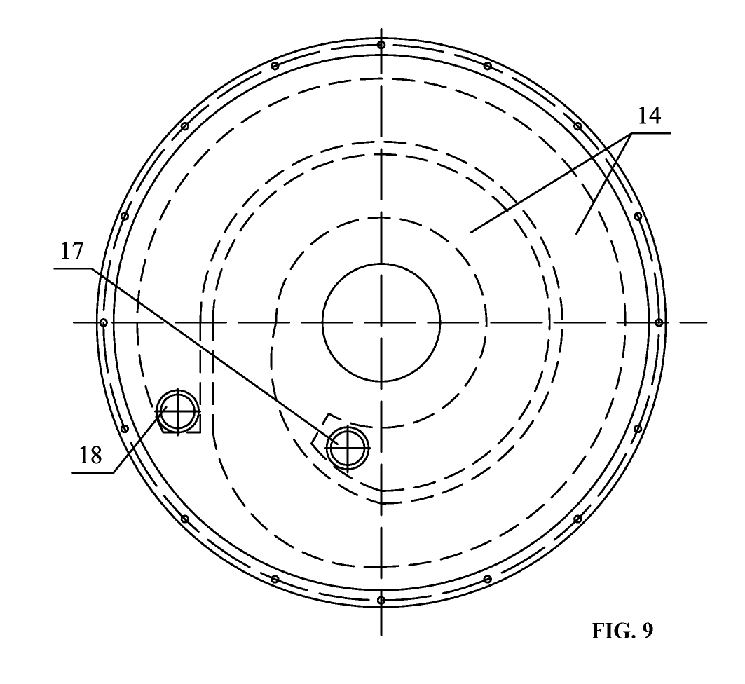

As shown in FIG. 8 and FIG. 9, several continuous rounds of the water channel 14 is deployed around the inlet hole 2 inside the upper part of the cover plate 3. Water inlet tube 18 is disposed at the beginning of the outmost round of the water channel 14. Water outlet tube 17 is disposed at the ending of the innermost round of water channel 14.

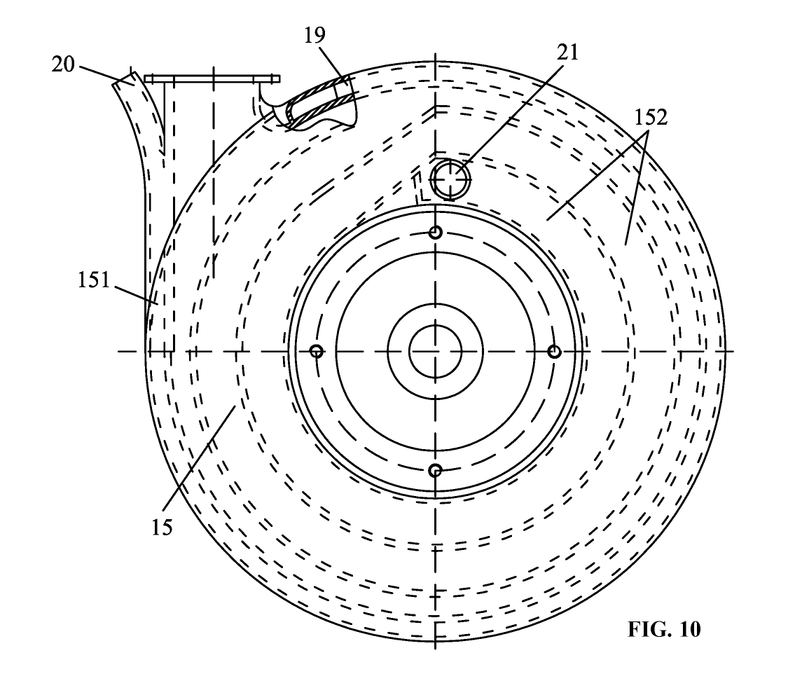

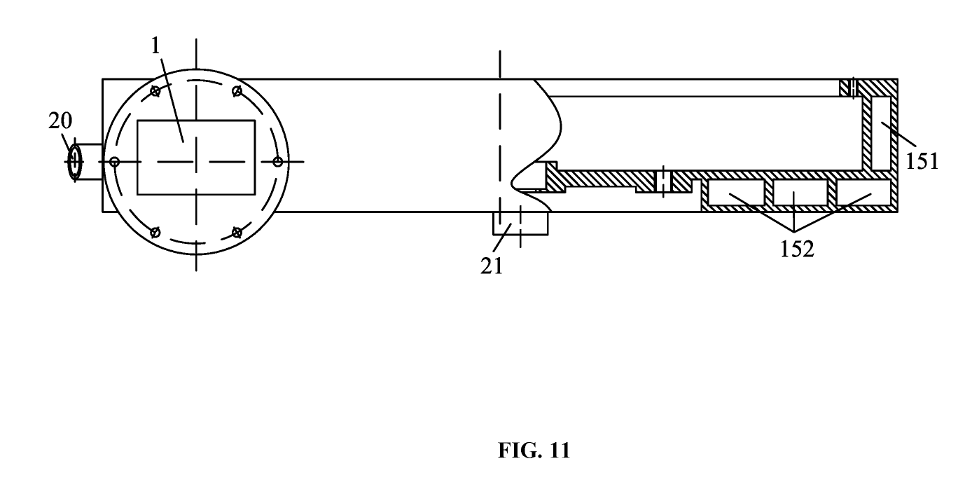

As shown in FIG. 10 and FIG. 11, the second annular water channel 15 is disposed inside the machine shell 4. The second annular water channel 15 can be further divided into a volute water channel 151 and a bottom case water channel 152. The volute water channel 151 is disposed in the outer part of the machine shell 4, while the bottom case water channel 152 is disposed as several continuous rounds of water channel around the flange plate of motor 10 added in the bottom of the machine shell 4. Rectangular water hole 19 connects the volute water channel 151 with the bottom case water channel 152 at the bottom of the machine shell 4. Water inlet tube 20 of the second annular water channel is located near the outlet hole 1 on the machine shell 4. Water outlet tube 21 of the second annular water channel is located near the motor 10 at the bottom of the machine shell 4.

During operation, when materials entering the machine shell 4 through the inlet hole 2 of the cover plate 3, a fluid of cooling water flows into the volute water channel 151 through the water inlet tube 20 of the machine shell, circulates nearly one outer round of the machine shell then enters outer ring of the bottom case water channel 152 through the water hole 19, and then flows several rounds inside the bottom case water channel 152, finally runs out from water outlet tube 21 of the second annular water channel.

In the process mentioned above, cooling water removes heat generated by material pulverization and motor rotation, achieving the goal of lowering the temperature of pulverized materials.

In this example, besides all the advantages mentioned in example 1, the grinder has the advantage of cooling down the temperature of pulverized materials. When the grinder in example 2 is used for grain processing, low-temperature operation retains the original fragrance of the grains, reduces the nutritional ingredient loss and ensures that pulverized products have good performance in food preparation.

When the grinder is used for processing thermoplastics, the pulverizing efficiency is increased substantially.

Unless otherwise indicated, the numerical ranges involved include the beginning and end values. It will be obvious to those skilled in the art that changes and modifications may be made, and therefore, the aim in the appended claims is to cover all such changes and modifications.

What is claimed is:

1. A grinder, comprising:
a motor comprising a motor shaft;
a machine shell comprising a top surface and a bottom surface;
a rotor unit, the rotor unit comprising a wheel hub, a rotor disk fixed on the wheel hub, and at least 3 rounds of the rotor pins installed on the rotor disk; and
a stator unit, the stator unit comprising a cover plate, a stator disk fixed on the cover plate, and at least 3 rounds of the stator pins installed on the stator disk;
wherein:
the cover plate is fixedly connected to the top surface of the machine shell, and the motor is fixedly connected to the bottom surface of the machine shell;
the rotor unit is disposed in the machine shell and fixedly connected to the motor shaft via the wheel hub;
the stator unit is fixed on the top surface of the machine shell via the cover plate;
the rotor pins and the stator pins are the same in structure; each of the rotor pins and the stator pins comprises a quadrangular steel billet and a screwed or non-screwed connecting rod disposed on the steel billet; a cross section of the quadrangular steel billets is square; an anti-abrasion component is fixed on the quadrangular steel billet of the rotor/the stator pins;
the anti-abrasion component comprises two level parts and a V-shaped part; the two level parts are fixed on ends of two inclined faces of the V-shaped part, respectively; both the two level parts and the two inclined faces of the V-shaped part are disposed symmetrically about a center of the quadrangular steel billet;
the two level parts each comprise two to six steps;
the V-shaped part comprises an arc-shaped apical part, and an included angle α formed by the two inclined faces of the V-shaped part is between 80 and 140 degrees;
the two inclined faces and the arc-shaped apical part of the V-shaped part form a radial working face of the rotor/the stator pins, and the two to six steps of the two level parts form a tangential working face of the rotor/the stator pins;
inner and outer tangential working faces of the rotor pins and the inner and outer tangential working faces of the stator pins are peripherally tangential to a movement direction of the motor; and
arc faces of the radial working faces of the rotor pins and arc faces of the radial working faces of the stator pins are opposite to one another.

2. The grinder of claim 1, wherein the anti-abrasion component has a thickness of at least 2 millimeters; taking a direction of the steps of the inner or outer tangential working faces of the anti-abrasion component close to the radial working face as a front direction, a direction far from the radial working face as a rear direction, a height of the steps increases from 0.5 mm to 1.5 mm from the front direction to the rear direction successively.

3. The grinder of claim 2, wherein a width of a bottommost step of the inner or outer tangential working faces of the anti-abrasion component is no less than 1 mm; a width of an uppermost step of the inner or outer tangential working faces of the anti-abrasion component is between 3 mm and 15 mm.

4. The grinder of claim 1, wherein the steel billet and the anti-abrasion component are connected using soldering joint or bonding joint.

5. The grinder of claim 1, wherein a minimum space between the rotor pins and the stator pins is between 0.5 mm and 3 mm.

6. The grinder of claim 1, wherein a linear velocity of the rotor pins is between 50 meters per second and 150 meters per second.

7. The grinder of claim 1, wherein a top surface of the cover plate is provided with a plurality of first annular water channels; one end of the first annular water channels communicates with an inlet tube, and the other end of the first annular water channels communicates with an outlet tube.

8. The grinder of claim 1, wherein the bottom surface of the machine shell is provided with a plurality of the second annular water channels; the second annular water channels comprise a volute water channel and a bottom case water channel; one end of the volute water channel is connected to one end of the bottom case water channel through a water mouth; the other end of the volute water channel communicates with an inlet tube of the second annular water channels, and the other end of the bottom case water channel communicates with an outlet tube of the second annular water channels.

9. The grinder of claim 8, wherein the water mouth is rectangular.

10. The grinder of claim 7, wherein a heat-conducting plate is disposed between the stator disk and the cover plate.
